(19) United States
(12) Patent Application Publication
(10) Pub. No.: US 2026/0289574 A1
(43) Pub. Date: Sep. 24, 2026

(54) SYSTEM, METHOD, AND STORAGE MEDIUM

(71) Applicant: Toshiba Tec Kabushiki Kaisha, Tokyo (JP)

(72) Inventor: Hiroyasu AOKI, Izu Shizuoka (JP)

(21) Appl. No.: 19/435,686

(22) Filed: Dec. 29, 2025

(30) Foreign Application Priority Data
Mar. 24, 2025 (JP) 2025-048602

(51) Int. Cl. G06Q 20/40; G06Q 20/20; G06Q 20/24; G06Q 20/34

(52) U.S. Cl. CPC G06Q 20/405; G06Q 20/204; G06Q 20/24; G06Q 20/34; G06Q 20/209

(57) ABSTRACT

A system includes a server device configured to manage credit card transactions and a payment terminal configured to perform pre-authorization and post-authorization processes for executing credit card transactions. The pre-authorization process includes: upon receipt of an amount of a scheduled transaction and card information, transmitting the amount and the card information to the server device, and upon receipt of authorization information confirming reservation of an amount of credit from the server device, storing the authorization information, the amount of the scheduled transaction, and the card information as a record in the memory. The post-authorization process includes: displaying a screen showing authorization information corresponding to records in a selectable manner, upon selection of authorization information, displaying a screen through which an actual amount of the transaction corresponding to the selected authorization information can be input, and executing the transaction based on the actual amount using the card information.

### CROSS-REFERENCE TO RELATED APPLICATION

This application is based upon and claims the benefit of priority from Japanese Patent Application No. 2025-048602, filed Mar. 24, 2025, the entire contents of which are incorporated herein by reference.

### FIELD

Embodiments described herein relate generally to a system, a method, and a storage medium.

### BACKGROUND

There is a process related to credit card payment called pre-authorization. Pre-authorization is a process of reserving a part (in some cases, the entirety) of available credit (or credit limit) for credit card payment. This process is performed, for example, before a relatively expensive service is provided to avoid a situation in which payment by a credit card cannot be made after the service is provided.

When using funds reserved by pre-authorization to pay for a service after the service is provided, it is necessary to input an authorization code issued during the pre-authorization. Because the authorization code needs to be input manually while looking at the authorization code printed on a slip issued during the pre-authorization and the authorization code contains a large number of digits, this step is cumbersome. Also, the operator may incorrectly input the authorization code and need to repeat the step.

However, there is currently no product designed to simplify operations related to payment involving pre-authorization. There are only documents that disclose measures for dealing with situations in which authorization cannot be acquired due to communication failure.

### SUMMARY OF THE INVENTION

Embodiments of this disclosure facilitate payment involving pre- authorization.

According to an aspect of this disclosure, a system comprises: a server device configured to manage credit card transactions; and a payment terminal that is connected via a network to the server device and includes: a communication interface, a display device, a memory, and a processor configured to execute a program that is stored in the memory to perform pre-authorization and post-authorization processes for executing credit card transactions. The pre-authorization process includes: upon receipt of an amount of a scheduled transaction and card information of a credit card to be used for the scheduled transaction, controlling the communication interface to transmit the amount and the card information to the server device to reserve an amount of credit associated with the credit card and corresponding to the amount of the scheduled transaction, and upon receipt of authorization information confirming reservation of the amount of credit from the server device, storing the authorization information, the amount of the scheduled transaction, and the card information as a record in the memory. The post-authorization process includes: reading one or more records from the memory, and controlling the display device to display a first screen showing one or more pieces of authorization information corresponding to the one or more records in a selectable manner, upon selection of one of the one or more pieces of authorization information, controlling the display device to display a second screen through which an actual amount of the scheduled transaction corresponding to the selected authorization information can be input, and upon receipt of the card information corresponding to the selected authorization information, executing the scheduled transaction based on the actual amount using the card information and the selected authorization information.

### BRIEF DESCRIPTION OF THE DRAWINGS

FIG. 1 is a diagram illustrating a configuration of a credit card payment system according to an embodiment.

FIG. 2 is a block diagram illustrating an example of a hardware configuration of a payment terminal.

FIG. 3 is a block diagram illustrating an example of a functional configuration of a control unit of the payment terminal.

FIG. 4 is a flowchart illustrating an example of a process performed by the control unit of the payment terminal.

FIG. 5 is a diagram illustrating an example of a slip output by a printer of the payment terminal.

FIG. 6 is a diagram illustrating an example of a screen displayed by a display unit of the payment terminal

FIG. 7 is a diagram illustrating an example of a screen displayed by the display unit of the payment terminal.

FIG. 8 is a diagram illustrating an example of a screen displayed by the display unit of the payment terminal

FIG. 9 is a diagram illustrating an example of a screen displayed by the display unit of the payment terminal

FIG. 10 is a diagram illustrating an example of a screen displayed by the display unit of the payment terminal.

FIG. 11 is a diagram illustrating an example of a screen displayed by the display unit of the payment terminal

FIG. 12 is a diagram illustrating an example of a screen displayed by the display unit of the payment terminal

FIG. 13 is a diagram illustrating an example of a screen displayed by the display unit of the payment terminal.

FIG. 14 is a diagram illustrating an example of a screen displayed by the display unit of the payment terminal

FIG. 15 is a flowchart illustrating an example of a process performed by the control unit of the payment terminal

FIG. 16 is a diagram illustrating an example of a screen displayed by the display unit of the payment terminal.

FIG. 17 is a diagram illustrating an example of a screen displayed by the display unit of the payment terminal.

FIG. 18 is a diagram illustrating an example of a screen displayed by the display unit of the payment terminal.

FIG. 19 is a diagram illustrating an example of a screen displayed by the display unit of the payment terminal.

FIG. 20 is a diagram illustrating an example of a screen displayed by the display unit of the payment terminal.

FIG. 21 is a diagram illustrating an example of a screen displayed by the display unit of the payment terminal

FIG. 22 is a diagram illustrating an example of a screen displayed by the display unit of the payment terminal.

FIG. 23 is a diagram illustrating an example of a screen displayed by the display unit of the payment terminal.

FIG. 24 is a diagram illustrating an example of a screen displayed by the display unit of the payment terminal.

FIG. 25 is a flowchart illustrating an example of a process performed by the control unit of the payment terminal.

### DETAILED DESCRIPTION

Hereinafter, embodiments will be described in detail with reference to the drawings. However, this disclosure is not limited to the embodiments described below.

### First Embodiment

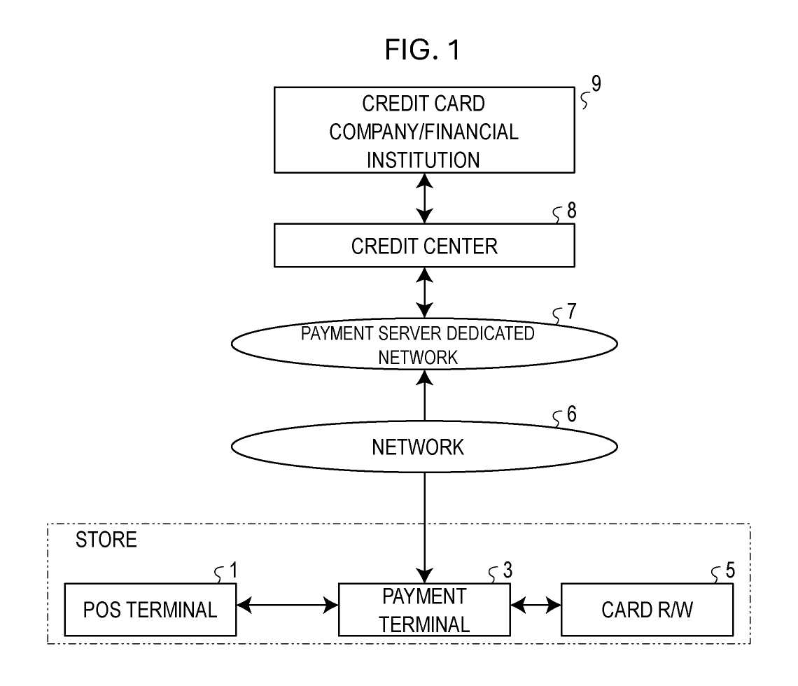

A first embodiment will be described with reference to the drawings. FIG. 1 is a diagram illustrating an example of a configuration of a credit card payment system. The credit card payment system includes, for example, a POS terminal 1, a payment terminal 3, a card reader/writer 5, a network 6, a payment server dedicated network 7, a credit center 8, and a credit card company/financial institution 9. The POS terminal 1, the payment terminal 3, and the card reader/writer 5 are provided in a store.

The POS terminal 1 is an example of a sales data processing device that is used, for example, to register items and make payment for the registered items. Note that "POS" is an abbreviation for "Point of Sale" and means point-of-sale information management. The POS terminal 1 performs point-of-sale information management.

The payment terminal 3 is used to make a cashless payment with a credit card, electronic cash, or the like. The POS terminal 1 performs cashless payment processes via the payment terminal 3.

The card reader/writer 5 is connected to the payment terminal 3, reads information (or card information) stored in media attached to various cards, such as a credit card and a loyalty card, outputs the information to the payment terminal 3, and writes information to the media. To be more specific, if a medium attached to a card is an IC, the card reader/writer 5 reads information (or card information) stored in the IC or writes information to the IC. If a medium attached to a card is a magnetic tape, the card reader/writer 5 reads information (or card information) stored in the magnetic tape. Card information includes, for example, a card number. The card information may also include, for example, an expiration date, the name of a cardholder, and the like, in addition to the card number.

The payment terminal 3 transmits and receives information related to credit card payment among cashless payment methods to and from the credit center 8 with which the store has a contract. Communication between the credit center 8 and the payment terminal 3 is performed via the network 6 and the payment server dedicated network 7.

The network 6 is implemented by, for example, a dedicated line or a VPN (Virtual Private Network) using a LAN (Local Area Network) or a public telecommunication network, such as the Internet.

The payment server dedicated network 7 also relays connection to, for example, an electronic money center, a slip storage center, a loyalty program operator, a maintenance server, and the like, in addition to the credit center 8. The loyalty program operator handles points and gifts, which are rewards for code payment. The maintenance server, for example, distributes programs.

The credit center 8 is an example of a server device that manages credit card transactions. The credit center 8 is, for example, a function on the cloud or a server and relays communication related to credit card transactions between the contracted store and the credit card company/financial institution 9. To be more specific, the credit center 8 transfers card information and the like received by the payment terminal 3 to the credit card company/financial institution 9 corresponding to the card information.

The credit card company/financial institution 9 is, for example, a function on the cloud or a server and stores and manages information related to payment handled by each credit card company or financial institution.

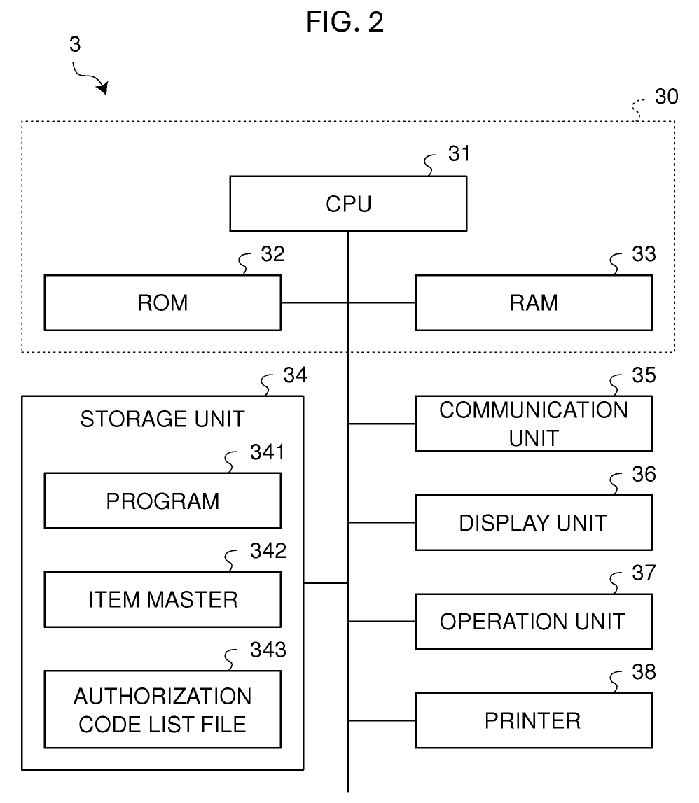

FIG. 2 is a block diagram illustrating an example of a hardware configuration of the payment terminal 3. The payment terminal 3 includes a CPU (Central Processing Unit) 31, a ROM (Read-Only Memory) 32, a RAM (Random Access Memory) 33, a storage unit 34, a communication unit 35, a display unit 36, an operation unit 37, and a printer 38.

The CPU 31 is an example of a processor and controls the operation of the payment terminal 3. The ROM 32 stores various programs. The RAM 33 is a workspace into which programs and various types of data are loaded.

The CPU 31, the ROM 32, and the RAM 33 are connected to each other via a bus or the like and constitute a control unit 30 with a computer configuration. In the control unit 30, the CPU 31 operates according to programs stored in the ROM 32 or the storage unit 34 and loaded into the RAM 33 and thereby performs various processes.

The storage unit 34 is an example of a storage device or a memory, such as a solid state drive (SSD) or a flash memory, and retains stored information even when the power is shut off. The storage unit 34 stores various types of information, such as a program 341 that can be executed by the CPU 31, an item master 342, and an authorization code list file 343.

The program 341 includes an application for causing the computer of the payment terminal 3 to perform sales data processing. According to the application, the CPU 31 causes the payment terminal 3 to operate as a sales data processing device.

The item master 342 is a table or a database that stores item codes of items sold in the store in association with information (or item information) of the items corresponding to the item codes. Here, each item code is an example of identification information for identifying an item and is, for example, a JAN code. The item information includes the name, the price (unit price), and the like of the item.

The authorization code list file 343 is an example of pre-authorization information that is related to pre-authorization of credit card payment and is organized in, for example, a table format. The authorization code list file 343 includes, for example, the following information items.

### Pre-Authorization Code List

Authorization code

Date and time

Transaction amount

Membership number

The authorization code is formed by numbers and/or symbols and is identification information for uniquely identifying each set of pre-authorization information. The authorization code is an example of authorization information. "Date and time" indicates the date and time when pre-authorization is performed.

Here, pre-authorization is a process that, by approving a specified amount of money prior to the provision of a service, reserves a part (or the entirety) of the available credit and ensures that payment for a transaction scheduled for credit card payment can be made. The part (or the entirety) of the available credit reserved through pre-authorization (hereafter referred to as “reserved credit”) is released when the reserved credit is not used for a predetermined period of time.

"Amount" indicates the upper limit of the amount of money that can be actually paid. That is, the actual payment after the provision of the service can be made using the reserved credit when the transaction amount is less than or equal to the value set in the "Amount".

"Membership number" indicates, for example, a card number written on a credit card. The card number is identification information of a customer for a credit card company and is used as a membership number.

In the authorization code list file 343, the above information items are associated with each other and form one record.

The communication unit 35 is an example of a communication interface and connects the control unit 30 (or the payment terminal 3) to other devices for communication. Other devices include, for example, internal devices, such as the POS terminal 1, in the store and external devices, such as the credit center 8, outside the store. The payment terminal 3 is connected to the internal devices via a direct wired connection, such as a USB connection, or a local area network (LAN) provided in the store. Also, the payment terminal 3 is connected to the external devices via the network 6.

The display unit 36 is an example of a display device, such as a liquid crystal display (LCD). The display unit 36 displays various types of information under the control of the CPU 31. For example, the display unit 36 displays operation screens related to sales data processing.

The operation unit 37 is an input device, such as a keyboard, a pointing device, or a touch panel. The operation unit 37 outputs input commands to the CPU 31. When the operation unit 37 is implemented by a touch panel, the touch panel is stacked on the screen of the display unit 36.

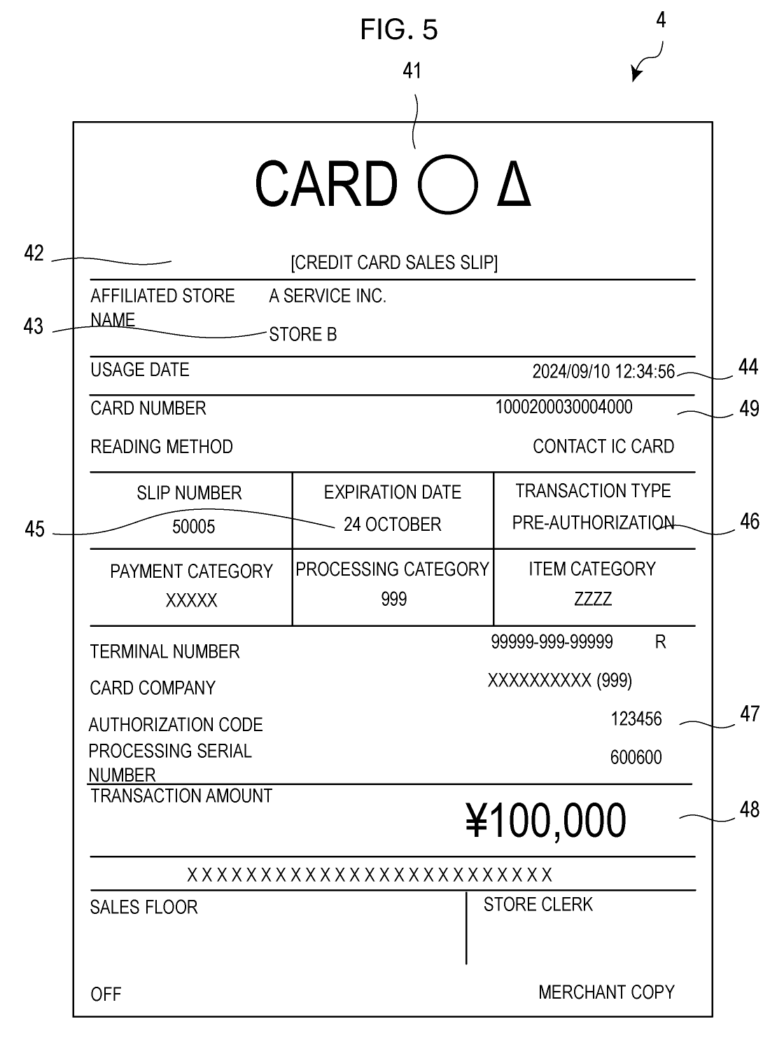

The printer 38 prints information on a print sheet and discharges the print sheet. For example, the printer 38 issues (or outputs) printed matter, such as a pre-authorization slip (see FIG. 5). The print sheet is an example of a sheet-shaped medium.

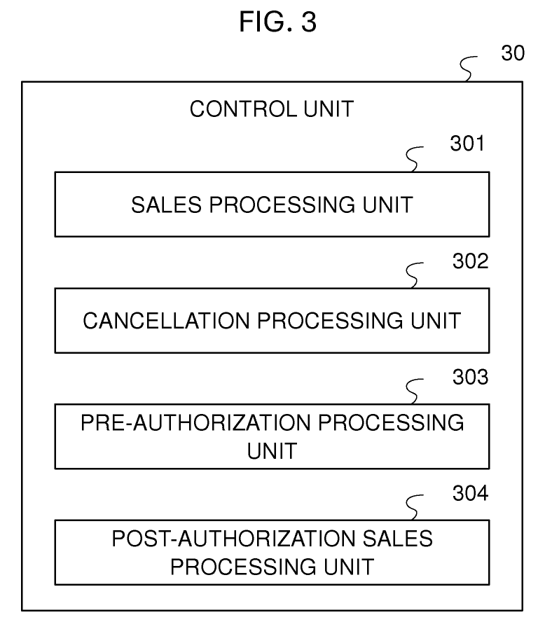

FIG. 3 is a block diagram showing an example of a functional configuration of the control unit 30 of the payment terminal 3. The control unit 30 includes various processing units, such as a sales processing unit 301, a cancellation processing unit 302, a pre-authorization processing unit 303, and a post-authorization sales processing unit 304. The CPU 31 functions as these processing units by executing programs.

The sales processing unit 301 performs a process (or sales processing) of identifying an item to be purchased by a customer and receiving payment for the item. The cancellation processing unit 302 performs a process of canceling the purchase of an item and returning the payment for the item.

The pre-authorization processing unit 303 is an example of a reservation unit that transmits a scheduled transaction amount, card information, and the like to the credit center 8 to reserve an amount of credit associated with a credit card and corresponding to the scheduled transaction amount and receives authorization information from the credit center 8. Thus, the pre-authorization processing unit 303 performs a process of approving payment of a specified amount in advance, that is, performs a pre-authorization process.

The pre-authorization processing unit 303 is an example of a recording processing unit and records authorization information, scheduled transaction amounts, and card information in the authorization code list file 343 in the storage unit 34.

The post-authorization sales processing unit 304 performs sales processing after pre-authorization. In other words, the post-authorization sales processing unit 304 performs payment using pre-authorization. More specifically, the post-authorization sales processing unit 304, as an example of a reading processing unit, reads information from the authorization code list file 343 when a predetermined operation is received. The post-authorization sales processing unit 304, as an example of a payment processing unit, performs credit card payment based on an authorization code selected from the authorization codes stored in the authorization code list file 343 and newly received card information.

### Pre-authorization Process

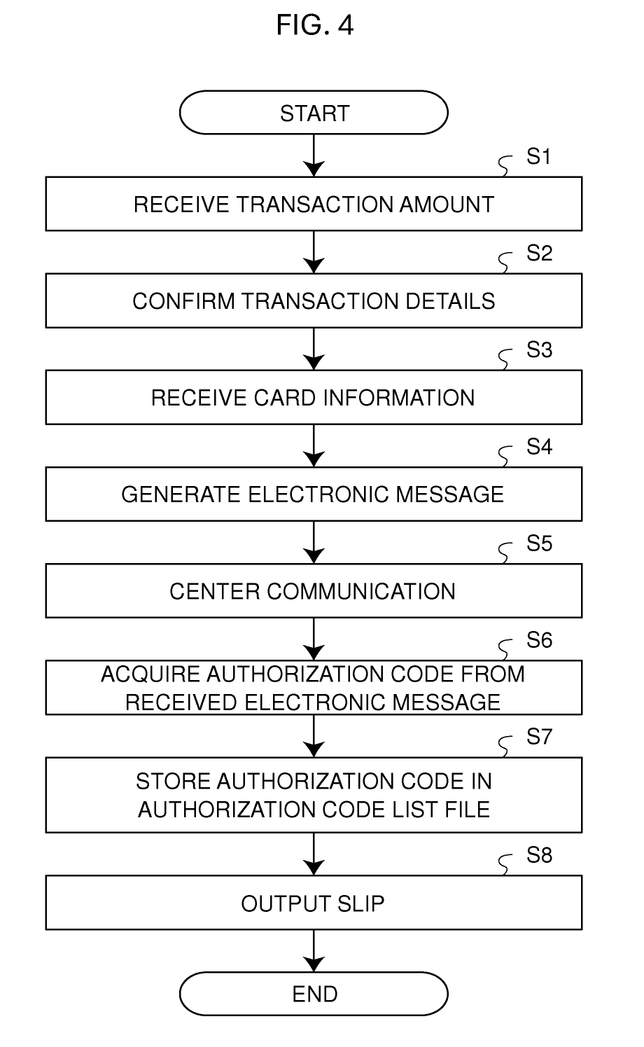

FIG. 4 is a flowchart illustrating an example of a process performed by the control unit 30 of the payment terminal 3. The flowchart schematically illustrates a pre-authorization process. The processor (or CPU 31) of the payment terminal 3 may be configured to execute a program stored in a memory (e.g., the storage unit 34 or the RAM 33) to perform the steps in the process described below.

In the pre-authorization process, the control unit 30, as the pre-authorization processing unit 303, first receives an input of a scheduled transaction amount (step S1). Subsequently, the control unit 30 confirms transaction details including the scheduled transaction amount (step S2). That is, at step S2, the control unit 30 displays, on the display unit 36, a user interface (UI) component for receiving an operation indicating that the transaction details have been confirmed, together with the transaction details, and receives, via the operation unit 37, a signal indicating that the UI component has been operated.

Next, the control unit 30 receives an input of card information (step S3). That is, at step S3, the control unit 30 causes the card reader/writer 5 to read information stored in a medium attached to a credit card and acquires the read information.

Next, the control unit 30 generates an electronic message to be transmitted to the credit center 8 (step S4). The electronic message includes the scheduled transaction amount, information indicating that the type of transaction is pre-authorization, and identification information of the store in addition to the card number of the credit card.

Next, the control unit 30 performs center communication to transmit the electronic message to the credit center 8 and receive an electronic message as a response (step S5). In other words, the processor (or CPU 31) is configured to control the communication interface (or communication unit 35) to transmit the scheduled transaction amount and the card information to the server device (or credit center 8) to reserve an amount of credit associated with the credit card and corresponding to the scheduled transaction amount. Subsequently, the control unit acquires an authorization code from the received electronic message (step S6) and stores the authorization code in the authorization code list file 343 (step S7). In other words, upon receipt of authorization information confirming reservation of the amount of credit from the server device, the processor is configured to store the authorization information, the scheduled transaction amount, and the card information as a record in the memory. Then, the control unit 30 outputs a slip on which the transaction details are printed (step S8) and ends the pre-authorization process. In other words, after storing the record in the memory, the processor controls a printer (e.g., printer 38) to print the authorization information, the scheduled transaction amount, and the card information.

FIG. 5 is a diagram illustrating an example of a slip 4 output by the printer 38 of the payment terminal 3. The slip 4 includes a logo 41, a slip title field 42, a store name field 43, a usage date field 44, an expiration date field 45, a transaction type field 46, an authorization code field 47, a transaction amount field 48, a credit number field 49, and the like.

The logo 41 is, for example, an image visually representing the type of the slip 4. For example, "Credit Card Sales Slip" is printed on the slip name field 42. The name of the store (affiliated store) to which services are provided by the credit card company/financial institution 9 is printed in the store name field 43.

The date and time when the pre-authorization process is performed is printed on the usage date field 44. An expiration date of the pre-authorization is printed on the expiration date field 4. After the expiration date, the pre-authorized credit is released. On the transaction type field 46, for example, "Pre-Authorization" is printed. The authorization code is printed on the authorization code field 47. The amount of money reserved by pre-authorization is printed on the transaction amount field 48. A card number is printed on the credit number field 49.

The slip 4 is kept by the store and is referred to when payment is actually made after the service is provided.

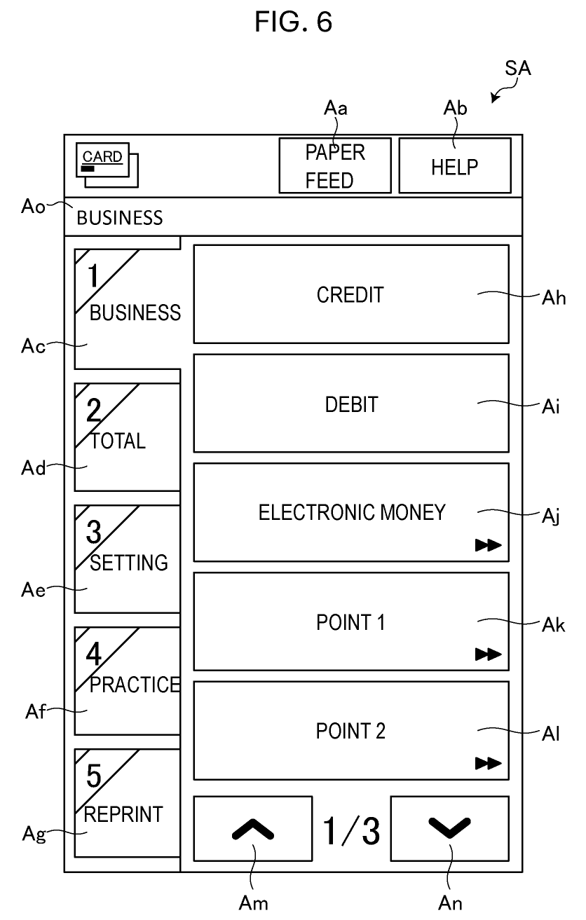

FIGS. 6 to 14 are diagrams illustrating examples of screens displayed by the display unit 36 of the payment terminal 3. In the descriptions of the screens, the same reference number is assigned to UI components with the same function and the descriptions of those components are not repeated.

A screen SA shown in FIG. 6 is a home screen of the payment terminal 3 and includes UI components Aa to An and a current position bar Ao.

When the UI component Aa receives an operation, the control unit 30 causes the printer 38 to feed a print sheet housed in the printer 38. When the UI component Ab receives an operation, the control unit 30 displays help (operation guide, etc.) related to a screen being displayed.

The UI components Ac to Ag are for receiving selection of a category of processes performed by the payment terminal 3. When the UI component Ac receives an operation, the control unit 30 displays options (UI components Ah to Al) corresponding to processes under the category "Business" on the display unit 36.

When the UI component Ad receives an operation, the control unit 30 causes the screen displayed by the display unit 36 to transition to a screen for performing processes under the category "Total". When the UI component Ae receives an operation, the control unit 30 causes the screen displayed by the display unit 36 to transition to a screen for performing processes under the category "Setting". When the UI component Af receives an operation, the control unit 30 causes the screen displayed by the display unit 36 to transition to a screen for performing processes under the category "Practice". When the UI component Ag receives an operation, the control unit 30 causes the screen displayed by the display unit 36 to transition to a screen for performing processes under the category "Reprint".

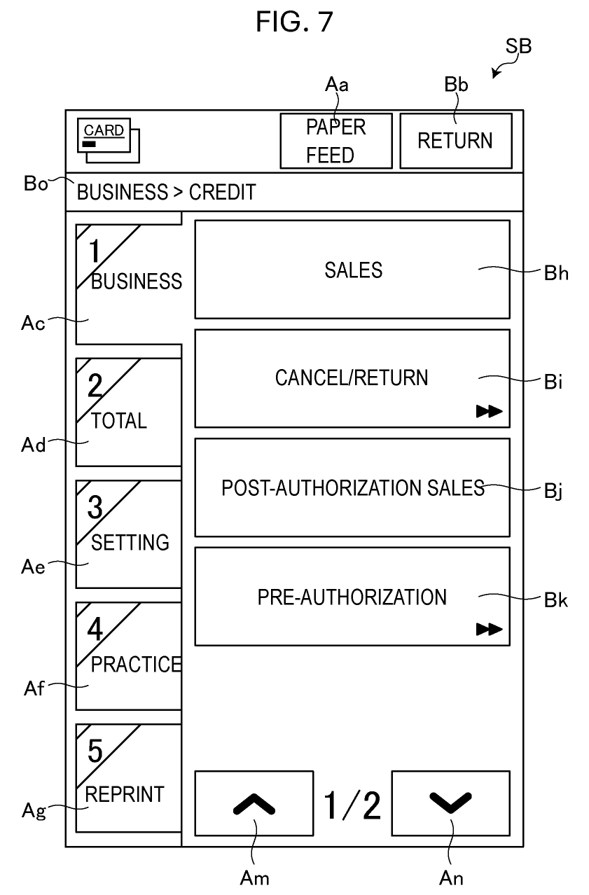

When the UI component Ah receives an operation, the control unit 30 causes the screen displayed by the display unit 36 to transition to a screen SB (see FIG. 7) for performing processes related to credit card payment.

When the UI component Ai receives an operation, the control unit 30 causes the screen displayed by the display unit 36 to transition to a screen for performing a process related to debit payment. When the UI component Aj receives an operation, the control unit 30 causes the screen displayed by the display unit 36 to transition to a screen for performing a process related to electronic money payment.

When the UI component Ak or Al receives an operation, the control unit 30 causes the screen displayed by the display unit 36 to transition to a screen for performing a process related to point awarding.

When the UI component Am or the UI component An receives an operation, the control unit 30 performs page navigation in a range in which the UI components Ah to Al are displayed.

The current position bar Ao displays the category and the hierarchy level of the screen currently being displayed. Screens displayed on the display unit 36 and processes that can be selected and executed while the screens are displayed are categorized and hierarchized. Since the screen SA is a screen for receiving selection of a process under the category of "Business", "Business" is displayed in the current position bar Ao .

The screen SB shown in FIG. 7 includes UI components Bb and Bh to Bk and a current position bar Bo. Since the screen SB is a screen for performing processes related to credit card payment, "Business > Credit" is displayed in the current position bar Bo.

The UI component Bb receives an operation for returning to the screen being displayed before the current screen. That is, when the UI component Bb receives an operation, the control unit 30 causes the screen displayed by the display unit 36 to transition to the screen SA.

When the UI component Bh receives an operation, the control unit 30 changes the screen displayed by the display unit 36 to a screen for performing a process related to sales registration. When the UI component Bi receives an operation, the control unit 30 causes the screen displayed by the display unit 36 to transition to a screen for performing a process related to cancellation and returning.

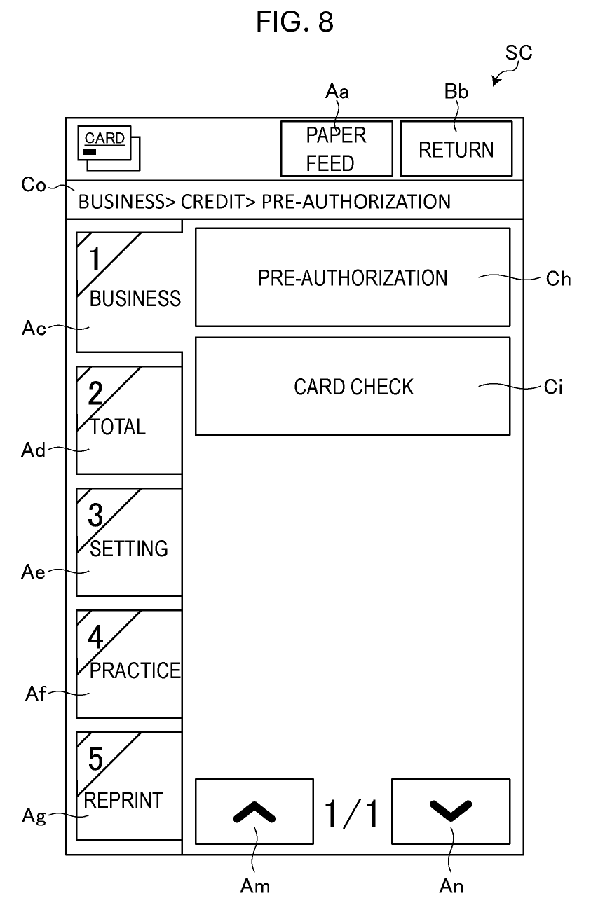

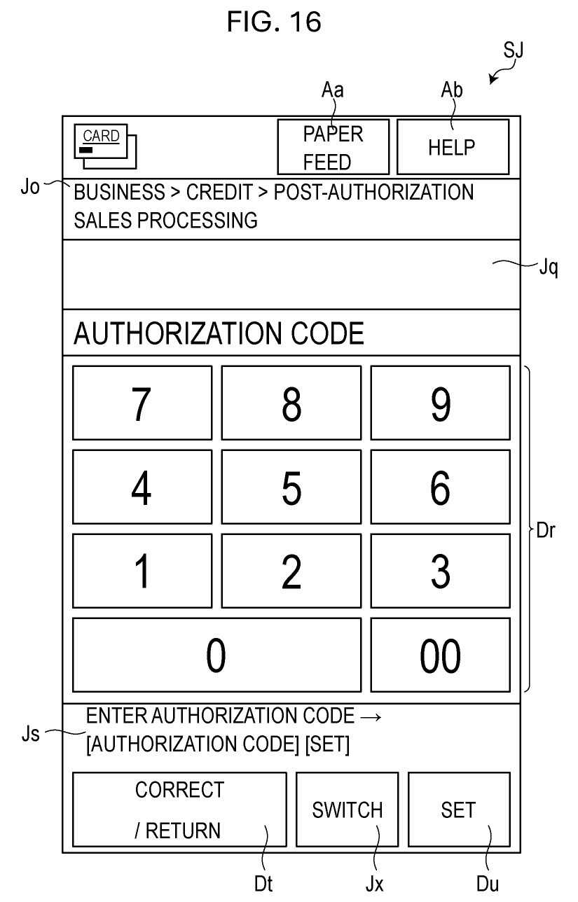

When the UI component Bj receives an operation, the control unit 30 causes the screen displayed by the display unit 36 to transition to a screen SJ (see FIG. 16) for performing a process related to post-authorization sales. When the UI component Bk receives an operation, the control unit 30 causes the screen displayed by the display unit 36 to transition to a screen SC (see FIG. 8) for performing a process related to pre-authorization.

The screen SC shown in FIG. 8 includes UI components Ch and Ci, and a current position bar Co. Since the screen SC is a screen for performing a process related to pre-authorization, "Business > Credit > Pre-Authorization" is displayed in the current position bar Co.

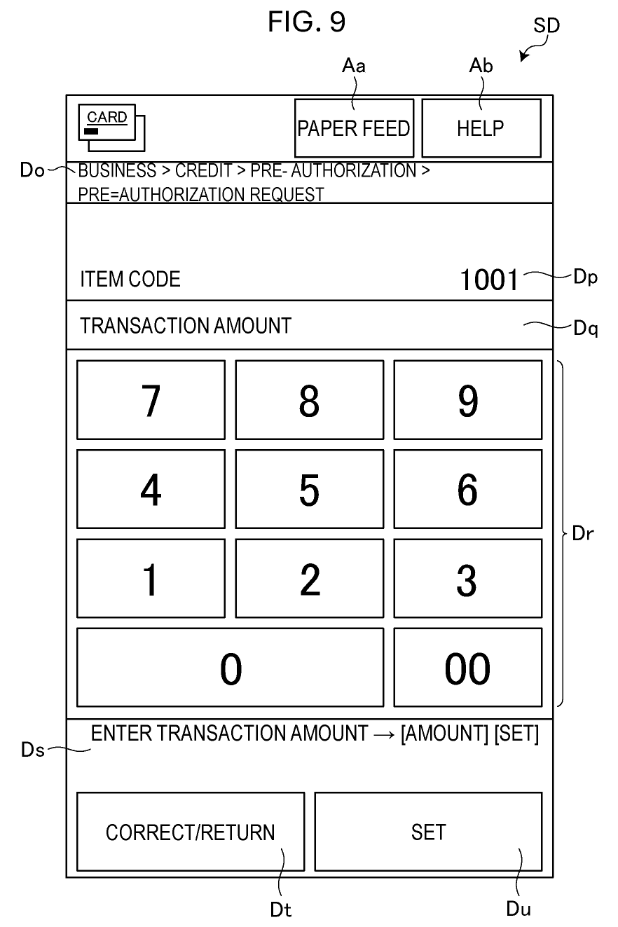

When the UI component Ch receives an operation, the control unit 30 starts the pre-authorization process illustrated in the flowchart of FIG. 4 and causes the screen displayed by the display unit 36 to transition to a screen SD (see FIG. 9) for performing a process related to pre-authorization.

When the UI component Ci receives an operation, the control unit 30 causes the screen displayed by the display unit 36 to transition to a screen for performing a process related to card checking.

The screen SD illustrated in FIG. 9 includes an item code field Dp, a transaction amount field Dq, a UI component Dr, a message Ds, UI components Dt and Du, and a current position bar Do. Since the screen SD is a screen for performing a process related to a pre-authorization request, "Business > Credit > Pre-Authorization > Pre-Authorization Request is displayed in the current position bar Do.

The UI component Dr is a collection of numeric keys (also referred to as a numeric keypad) and receives inputs of numbers in the item code field Dp or the transaction amount field Dq. The item code field Dp receives an input of identification information (or item code) of a service (or an item) that the customer is scheduled to receive. The transaction amount field Dq receives an input of an upper limit of the price of the item indicated by the item code.

The message Ds is a text that guides the operator to perform the next operation. For example, "Enter Transaction Amount" is displayed as the message Ds to prompt the operator to input a scheduled transaction amount in the transaction amount field Dq.

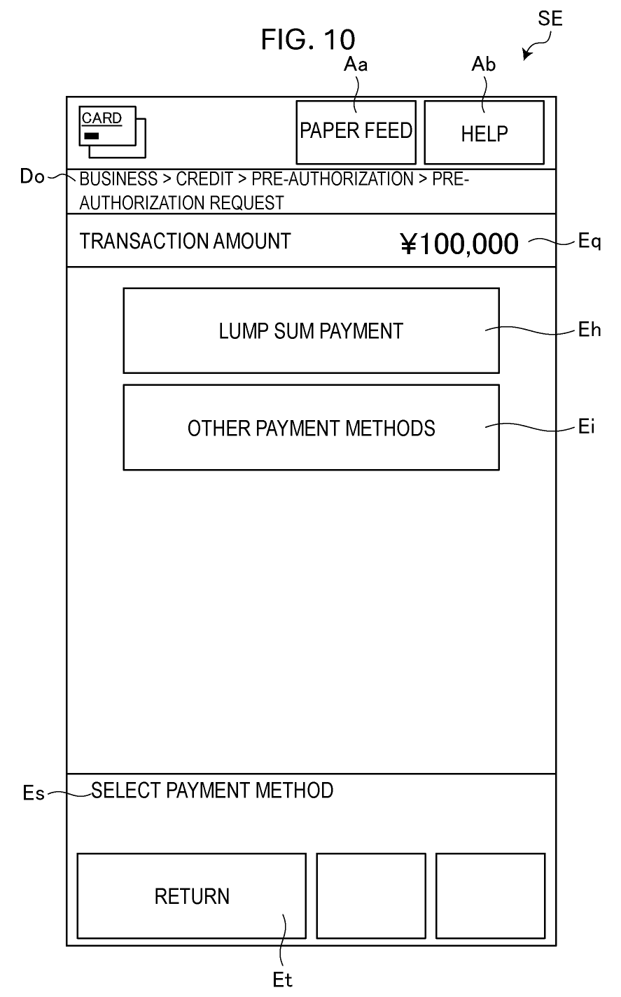

When the UI component Dt receives an operation, depending on the operation state, the control unit 30 receives a correction of a number being input or returns the hierarchy level of the screen to the previous hierarchy level. When the UI component Du receives an operation, the control unit 30 confirms the information input in the item code field Dp and the amount field Dq and causes the screen displayed by the display unit 36 to transition to a screen SE (see FIG. 10).

The screen SE shown in FIG. 10 includes a transaction amount field Eq, UI components Eh and Ei, a message Es, and a UI component Et. The transaction amount field Eq displays the value input to the transaction amount field Dq of the screen SD.

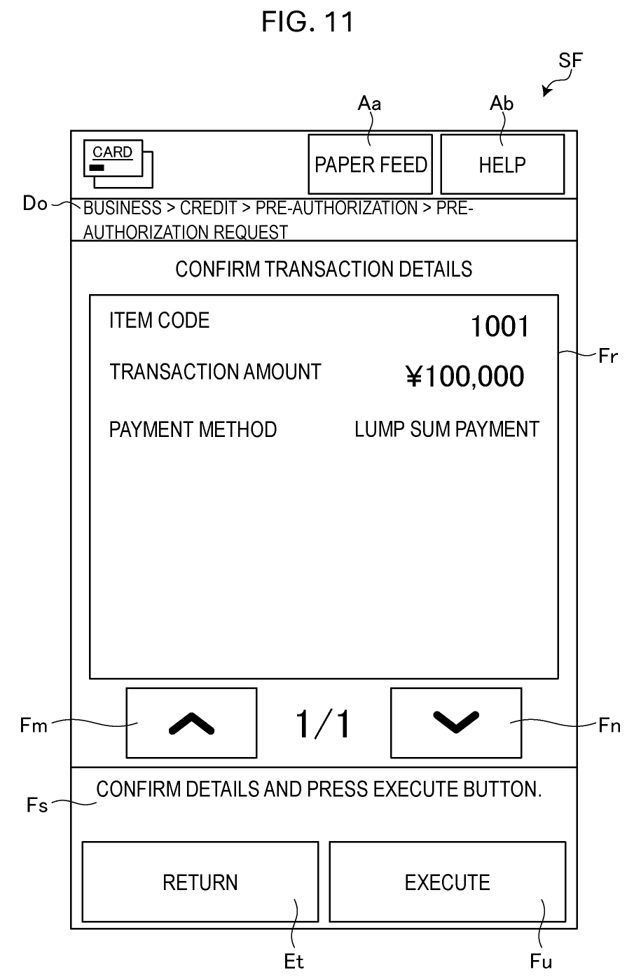

When the UI component Eh is operated, the control unit 30 receives a notification that the transaction amount displayed in the transaction amount field Eq is scheduled to be paid in a lump sum, and the control unit 36 causes the screen displayed by the display unit 36 to transition to a screen SF (see FIG. 11). When the UI component Ei is operated, the control unit 30 receives a notification indicating that the transaction amount displayed in the transaction amount field Eq is to be paid by a method other than the lump sum payment.

The message Es is a text that provides guidance to the operator regarding the next operation to be performed. For example, "Select Payment Method" is displayed as the message Es to prompt the operator to select the UI component Eh or Ei.

When the UI component Et receives an operation, the control unit 30 performs a screen transition to return the hierarchy level of the screen to the previous hierarchy level.

The control unit 30 receives inputs of an item code and a scheduled transaction amount via the screens SD and SE used as a graphical user interface (GUI) (step S1).

The screen SF illustrated in FIG. 11 is a screen for confirming transaction details related to pre-authorization. The screen SF includes a transaction details display field Fr, UI components Fm and Fn, a message Fs, and a UI component Fu.

The transaction details display field Fr is a field in which transaction details. such as an item code, a scheduled transaction amount, and a payment method, related to pre-authorization are displayed. When the UI component Fm or the UI component Fn is operated, the control unit 30 performs navigation of pages displayed in the transaction content display field Fr.

The message Fs is a text that provides guidance to the operator regarding the next operation to be performed. For example, "Confirm Details and Press Execute Button” is displayed as the message Fs.

The control unit 30 receives an operation related to the confirmation of the transaction details via the screen SF used as a GUI (step S2).

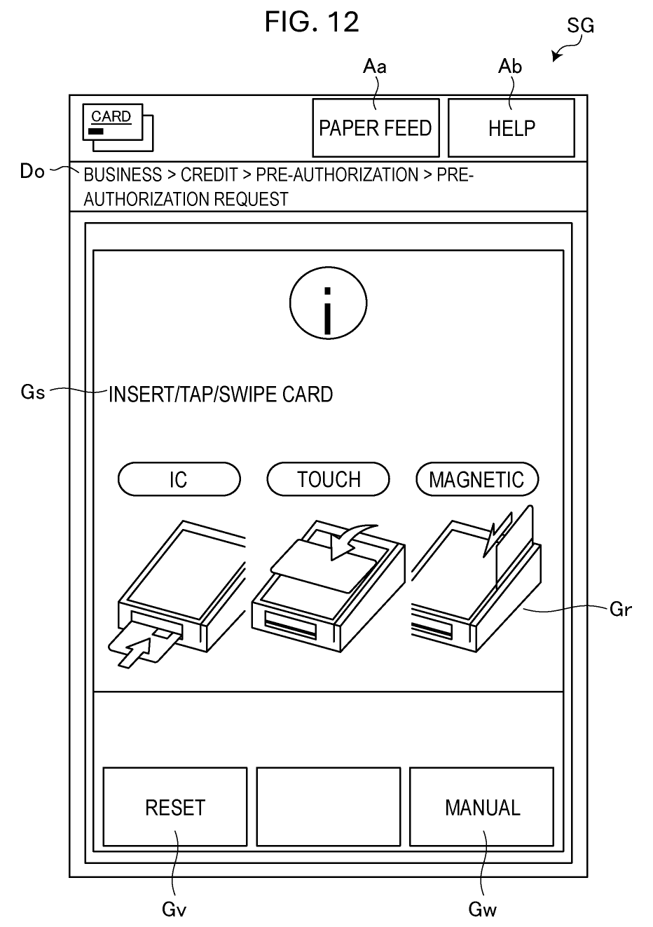

When the UI component Fu receives an operation, the control unit 30 receives a notification indicating that the transaction details displayed in the transaction details display field Fr have been confirmed and causes the screen displayed by the display unit 36 to transition to a screen SG (see FIG. 12).

The screen SG shown in FIG. 12 is a screen for receiving an input of card information and includes an explanatory diagram Gr, a message Gs, and UI components Gv and Gw.

The message Gs is a text that provides guidance to the operator regarding the next operation to be performed. For example, "Insert/Tap/Swipe Card” is displayed as the message Gs.

The explanatory diagram Gr is a diagram for explaining how to handle a credit card. For example, there are three types of methods for reading a credit card. In a first method, an IC tag provided on a credit card is read in a contact manner. An operator selecting this method inserts a credit card into a slot of the card reader/writer 5. In a second method, an IC tag provided on a credit card is read in a non-contact manner. An operator selecting this method holds a credit card over the card reader/writer 5 or brings the credit card into contact with the card reader/writer 5. In a third method, a magnetic tape on a credit card is read. An operator selecting this method inserts a credit card into a slot of the card reader/writer 5 and then slides the credit card.

When the UI component Gv receives an operation, the control unit 30 receives cancellation of pre-authorization. When the UI component Gw receives an operation, the control unit 30 receives an input of card information via numeric keys or the like.

The control unit 30 receives an input of card information via the screen SG used as a GUI (step S3). At this timing, the card reader/writer 5 or the payment terminal 3 may request the operator to input, for example, a PIN code, a password, or signature in accordance with the provisions of the store, the credit center 8, or the credit card company/financial institution 3.

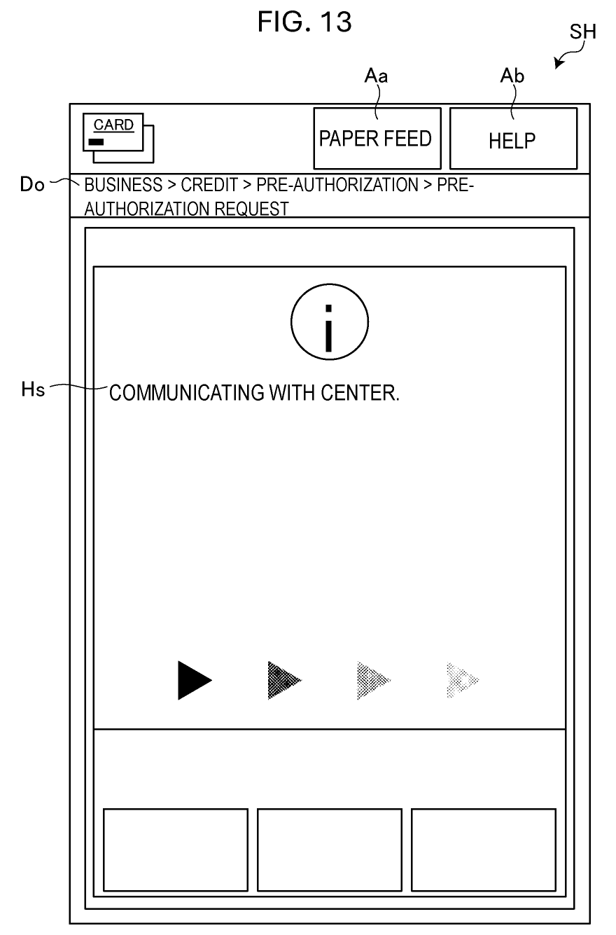

When the card information is input using one of the first to third methods, the control unit 30 causes the screen displayed by the display unit 36 to transition to a screen SH (see FIG. 13).

The screen SH shown in FIG. 13 is a screen for notifying the operator that communication with the credit center 8 is being performed and includes a message Hs. The message Hs is a text requesting the operator to wait. For example, "Communicating with Center” is displayed as the message Hs.

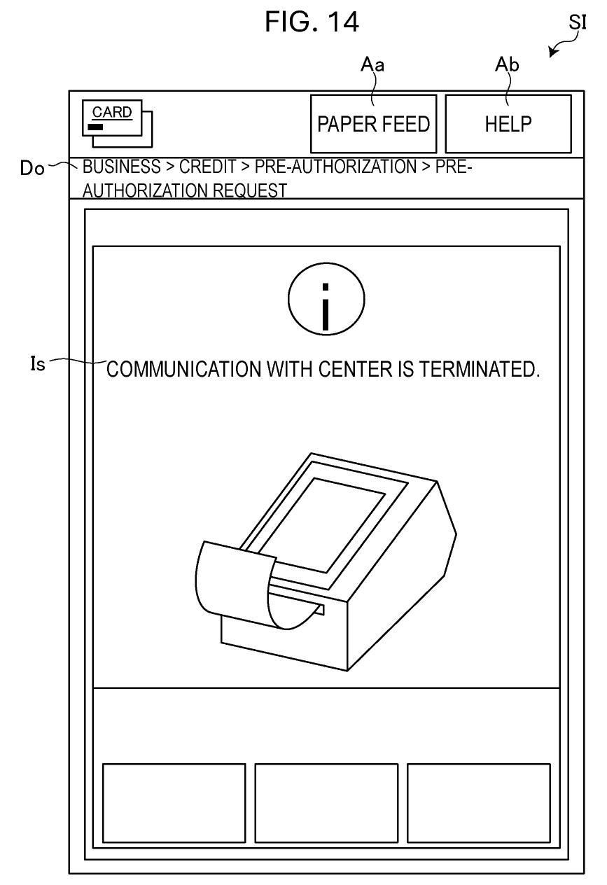

The control unit 30 performs steps S4 to S7 while the screen SH is displayed. When the communication with the credit center 8 is completed, the control unit 30 causes the screen displayed by the display unit 36 to transition to a screen SI (see FIG. 14).

The screen SI shown in FIG. 14 is a screen for notifying the operator that the communication with the credit center 8 has been terminated and includes a message Is. The message Is is a text for notifying the operator that the process related to pre-authorization has been completed. For example, "Communication with Center Is Terminated” is displayed as the message Is.

When the screen SI is displayed, the control unit 30 outputs a slip (step S8).

### Post-Authorization Sales Processing

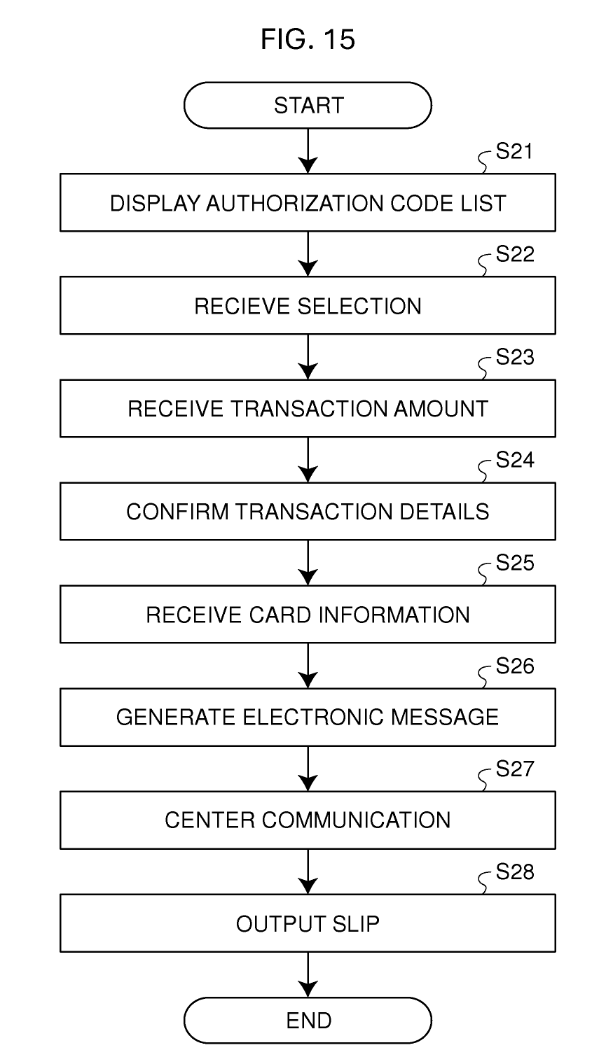

FIG. 15 is a flowchart illustrating an example of a process performed by the control unit 30 of the payment terminal 3. The flowchart schematically illustrates a process related to payment using pre-authorization. The processor (or CPU 31) of the payment terminal 3 may be configured to execute a program stored in a memory (e.g., the storage unit 34 or the RAM 33) to perform the steps in the process described below.

When making payment using pre-authorization, the control unit 30, as the post-authorization sales processing unit 304, first displays an authorization code list (step S21) and receives an operation of selecting one of the authorization codes in the authorization code list (step S22). In other words, the processor (or CPU 31) is configured to control a display device (or display unit 36) to display a screen including a list of records, each of which includes authorization information, a scheduled transaction amount, and card information and is read from the memory (e.g., the storage unit 34 or the RAM 33), and to receive a selection of one of the records via the screen.

Subsequently, the control unit 30 receives an input of an actual transaction amount (step S23), confirms transaction details (step S24), and receives an input of card information (step S25). In other words, the processor is configured to control the display device to display screens for prompting an operator to input an actual transaction amount and to newly input card information. Here, steps S23 to S25 are the same as steps S1 to S3, and therefore detailed descriptions of these steps are omitted.

Next, the control unit 30 generates an electronic message to be transmitted to the credit center 8 (step S26). The electronic message includes the transaction amount, the authorization code, the identification information of the store, and the like, in addition to the card number of the credit card.

Next, the control unit 30 performs center communication to transmit the electronic message to the credit center 8 and receives an electronic message as a response (step S27). In other words, the processor is configured to control the communication interface to transmit the authorization information in the selected one of the records, the actual transaction amount, and the newly input card information to the server device to perform credit card payment of the actual transaction amount based on the authorization information. Subsequently, when the control unit 30 determines that the payment using pre-authorization has been completed based on the received electronic message, the control unit 30 outputs a slip on which the transaction details are printed (step S28) and ends the process. In other words, upon receipt of a response indicating completion of the credit card payment from the server device, the processor is configured to control the printer to print transaction details including the actual transaction amount.

FIGS. 16 to 24 are diagrams illustrating examples of screens displayed by the display unit 36 of the payment terminal 3. When the UI component Bj is operated again on the screen SB illustrated in FIG. 7, the control unit 30 causes the screen displayed by the display unit 36 to transition to a screen SJ (see FIG. 16) for performing post-authorization sales processing.

The screen SJ illustrated in FIG. 16 includes an authorization code field Jq, a message Js, a UI component Jx, and a current position bar Jo. The screen SJ is a screen for performing a process related to payment (or post-authorization sales processing) using pre-authorization. For example, "Business > Credit > Post-Authorization Sales Processing" is displayed in the current position bar Jo.

The UI component Dr receives inputs of numbers in the authorization code field Jq.

The message Js is a text that provides guidance to the operator regarding the next operation to be performed. For example, "Enter Authorization Code" is displayed as the message Js to prompt the operator to input an authorization code in the authorization code field Jq.

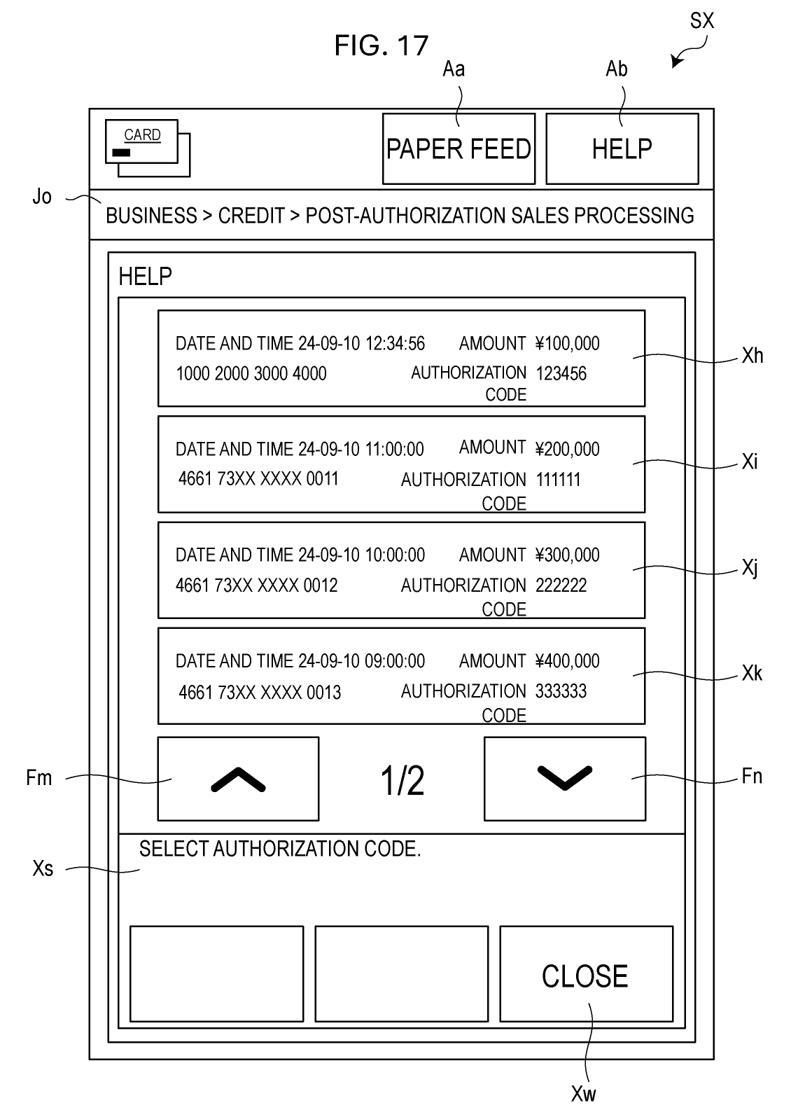

When the UI component Jx receives an operation, the control unit 30 causes the screen displayed by the display unit 36 to transition to a screen SX (see FIG. 17).

The screen SX illustrated in FIG. 17 is an example of an authorization code selection screen and is a GUI for displaying an authorization code list (step S21) and receiving selection of an authorization code. The screen SX may be a pop-up window displayed to overlap the screen SJ. The screen SX includes UI components Xh to Xk, a message Xs, and a UI component Xw.

The UI components Xh to Xk function as options for selecting authorization codes. The UI components Xh to Xk are associated with sets of information (or records) stored in the authorization code list file 343 in a one to-one relationship, and the corresponding information is displayed on each of the UI components Xh to Xk.

When one of the UI components Xh to Xk is operated, the control unit 30 determines that the authorization code displayed on the operated one of the UI components Xh to Xk is selected, returns (or transitions) to the screen SJ, and displays the selected authorization code in the authorization code field Jq.

When the UI component Fm or the UI component Fn receives an operation, the control unit 30 performs page navigation in a range in which the UI components Xh - Xk are displayed. When the UI component Xw is operated, the control unit 30 closes the screen SX and returns (or transitions) to the screen SJ.

The operator refers to a slip 4 having the same card number as that of the credit card presented by the customer to confirm the authorization code. The authorization code can be manually input using the UI component Dr on the screen SJ shown in FIG. 16. However, because each authorization code contains a large number of digits, it is possible to greatly reduce the burden of inputting an authorization code by referring to information displayed on the UI components Xh to Xk, selecting one of the UI components Xh to Xk on the screen SX shown in FIG. 17, and thereby selecting one of the sets of information (or records) stored in the authorization code list file 343.

The control unit 30 receives selection of an authorization code via the screens SJ and SX used as a GUI (step S22).

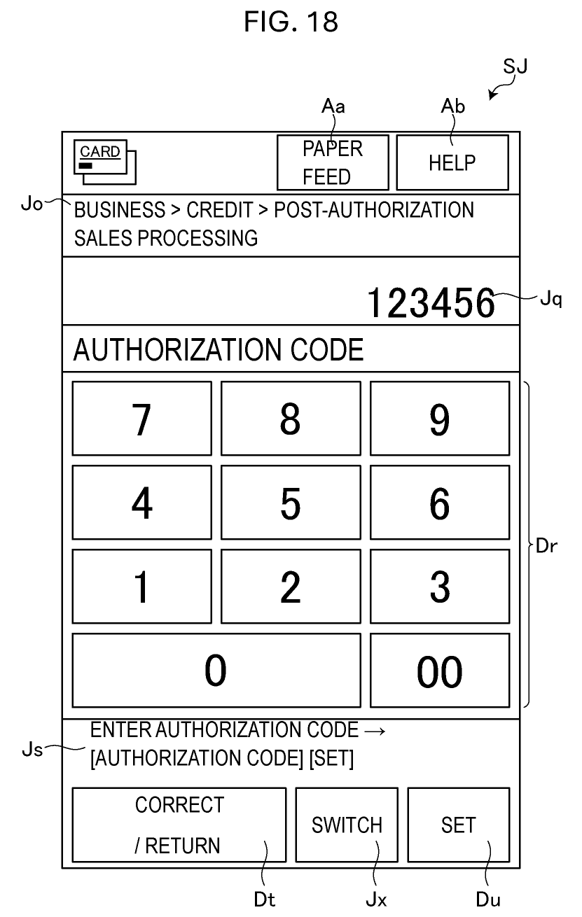

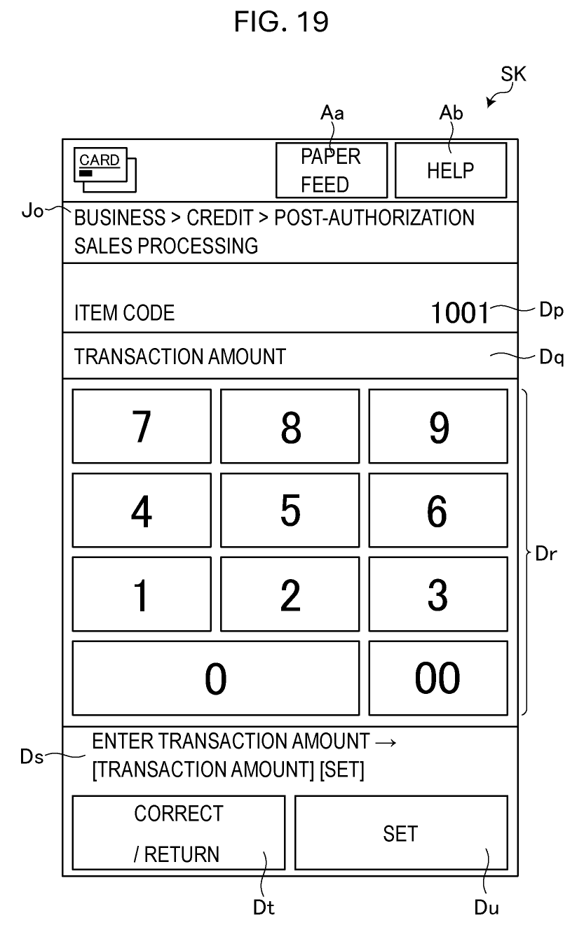

FIG. 18 shows a state of the screen SJ in which an authorization code has been input in the authorization code field Jq. When the UI component Du is operated on the screen SJ illustrated in FIG. 18, the control unit 30 confirms the authorization code input in the authorization code field Jq and causes the screen displayed by the display unit 36 to transition to a screen SK (see FIG. 19).

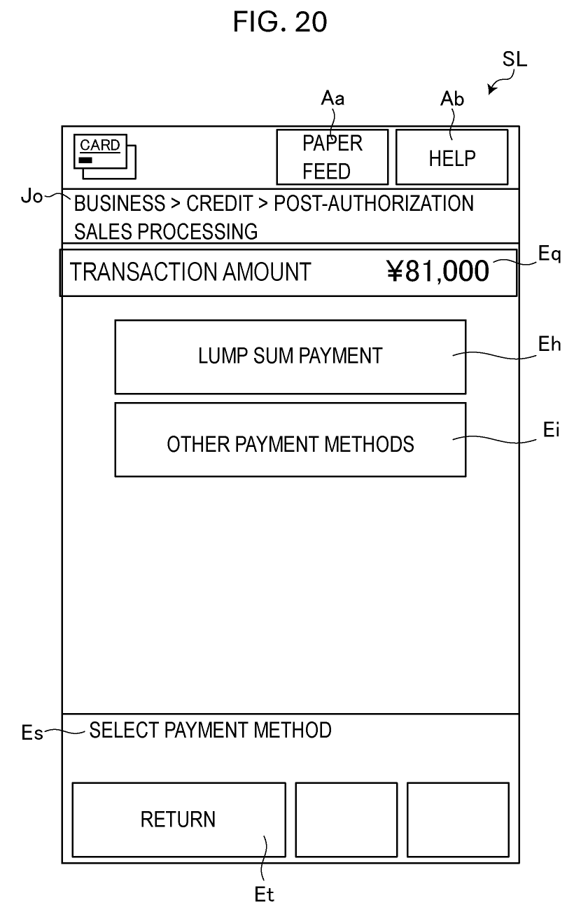

The screen SK shown in FIG. 19 is the same as the screen SD (FIG. 9) except for a current position bar Jo, and therefore, some of the descriptions of the screen SK are omitted. When the UI component Du is operated on the screen SK, the control unit 30 confirms information input in the item code field Dp and the amount field Dq and causes the screen displayed by the display unit 36 to transition to a screen SL (see FIG. 20).

The screen SL shown in FIG. 20 is the same as the screen SE (FIG. 10) except for a current position bar Jo, and therefore, some of the descriptions of the screen SL are omitted.

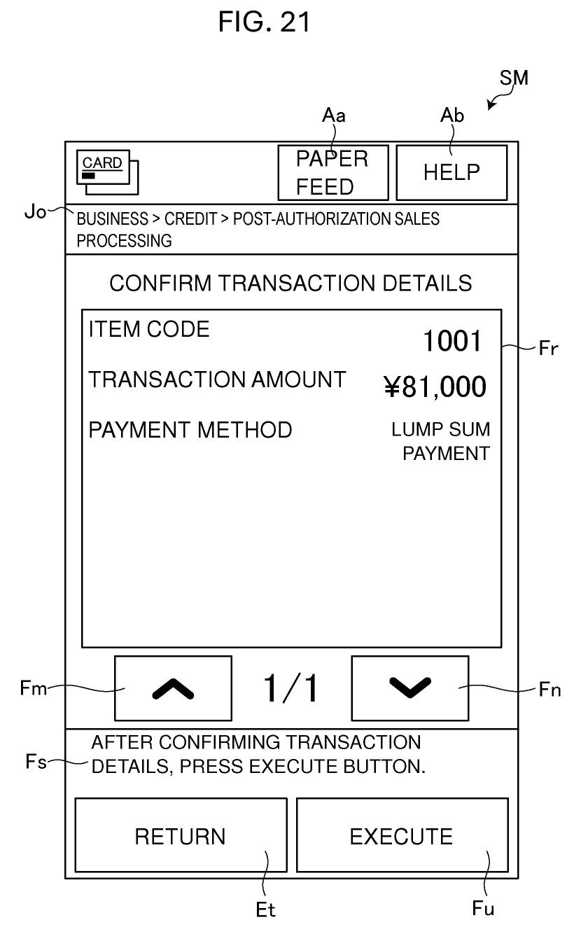

When the UI component Eh is operated on the screen SL, the control unit 30 receives an instruction to make lump sum payment of the transaction amount displayed in the transaction amount field Eq and causes the screen displayed by the display unit 36 to transition to a screen SM (see FIG. 21). When the UI component Ei is operated on the screen SL, the control unit 30 receives an instruction to pay the transaction amount displayed in the transaction amount field Eq by a method other than the lump sum payment.

The control unit 30 receives inputs of the item code and the transaction amount via the screens SK and SL used as GUIs (step S23).

The screen SM illustrated in FIG. 21 is a screen for confirming the details of payment using pre-authorization (or post-authorization sales processing). The screen SM is the same as the screen SF (FIG. 11) except for a current position bar Jo, and therefore, some of the descriptions of the screen SM are omitted.

The control unit 30 receives operations related to confirmation of the details of payment using pre-authorization (or post-authorization sales processing) via the screen SM used as a GUI (step S24).

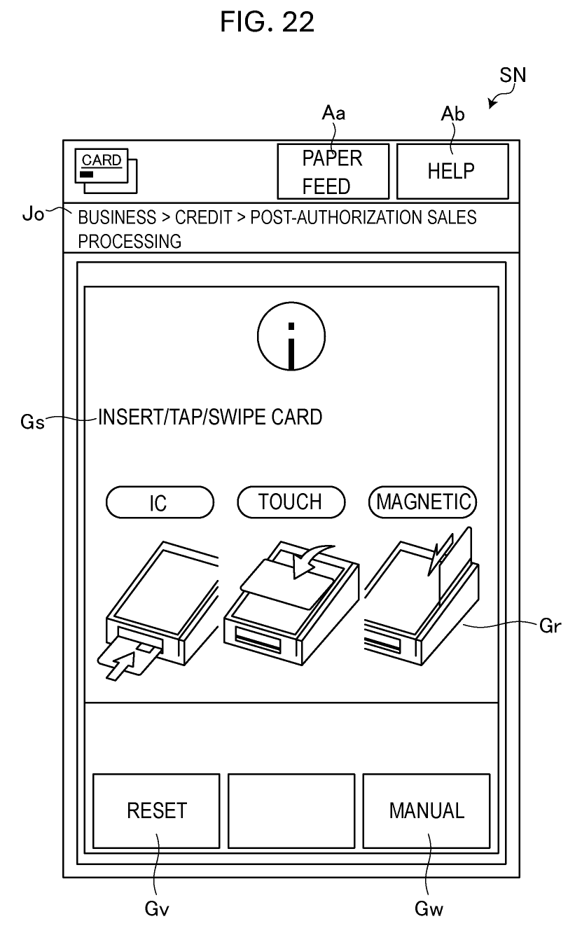

When the UI component Fu receives an operation, the control unit 30 receives a notification indicating that the details of payment displayed in the transaction details display field Fr has been confirmed and causes the screen displayed by the display unit 36 to transition to a screen SN (see FIG. 22).

The screen SN illustrated in FIG. 22 is a screen for receiving an input of card information. The screen SN is the same as the screen SG (FIG. 12) except for a current position bar Jo, and therefore, some of the descriptions of the screen SN are omitted.

When the UI component Gv receives an operation, the control unit 30 receives cancellation of the post-authorization sales processing.

The control unit 30 receives an input of card information via the screen SN used as a GUI (step S25).

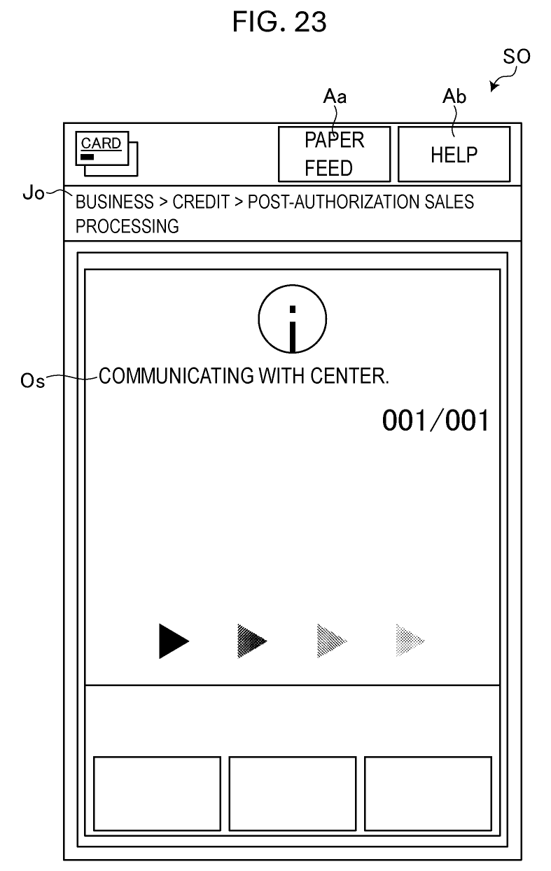

When the card information is input by any of the methods, the control unit 30 causes the screen displayed by the display unit 36 to transition to a screen SO (see FIG. 23).

The screen SO shown in FIG. 23 is a screen for notifying the operator that communication with the credit center 8 is being performed and includes a message Os. The message Os is a text requesting the operator to wait. For example, "Communicating with Center” is displayed as the message Os.

The control unit 30 performs steps S26 to S27 while the screen SO is displayed. At this timing, information associated with the used authorization code may be deleted from the authorization code list file 343.

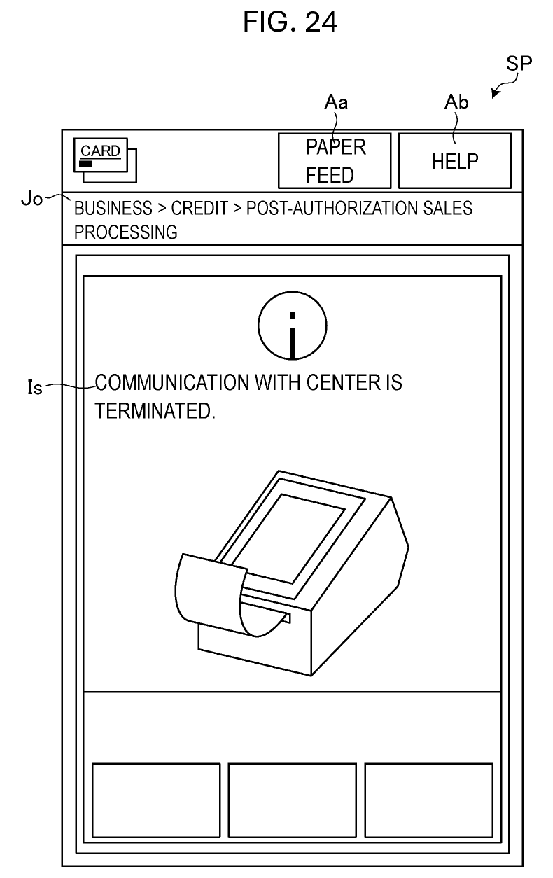

When the communication with the credit center 8 is completed, the control unit 30 causes the screen displayed by the display unit 36 to transition to a screen SP (see FIG. 24).

The screen SP shown in FIG. 24 is a screen for notifying the operator that the communication with the credit center 8 has been completed. The screen SP is the same as the screen SI (FIG. 14) except for a current position bar Jo, and therefore descriptions of the screen SP are omitted.

When the screen SP is displayed, the control unit 30 outputs a slip (step S28).

As described above, according to the first embodiment, authorization codes of pre-authorization are stored, and options corresponding to the authorization codes are displayed during the post-authorization sales processing to enable selection of one of the authorization codes. This can greatly reduce the burden of inputting authorization codes and thereby makes it possible to facilitate the use of pre-authorization.

In the above embodiment, the credit card payment system includes the POS terminal 1. However, the present disclosure is not limited to this example. That is, a store that uses the credit card payment system does not have to include the POS terminal 1.

In the above embodiment, the authorization code list file 343 is organized in a table format. However, the present disclosure is not limited to this example. As another example, the authorization code list file 343 may be organized in a text format.

The above-described embodiment can be modified and implemented by changing a part of the configuration or the function of each of the above-described devices as appropriate. Therefore, hereinafter, variations of the above-described embodiment will be described as other embodiments. Note that features different from those of the above-described embodiment will be mainly described below. Also, the same reference numbers as those used in the above embodiment are used for common components and features, and detailed descriptions of those components and features are omitted. The variations described below may be implemented individually or in combination as appropriate.

### Second Embodiment

The post-authorization sales processing unit 304 of the present embodiment, as an example of a payment processing unit, newly receives card information, acquires information corresponding to the received card information from the authorization code list file 343, and executes credit card payment using the acquired information and the card information.

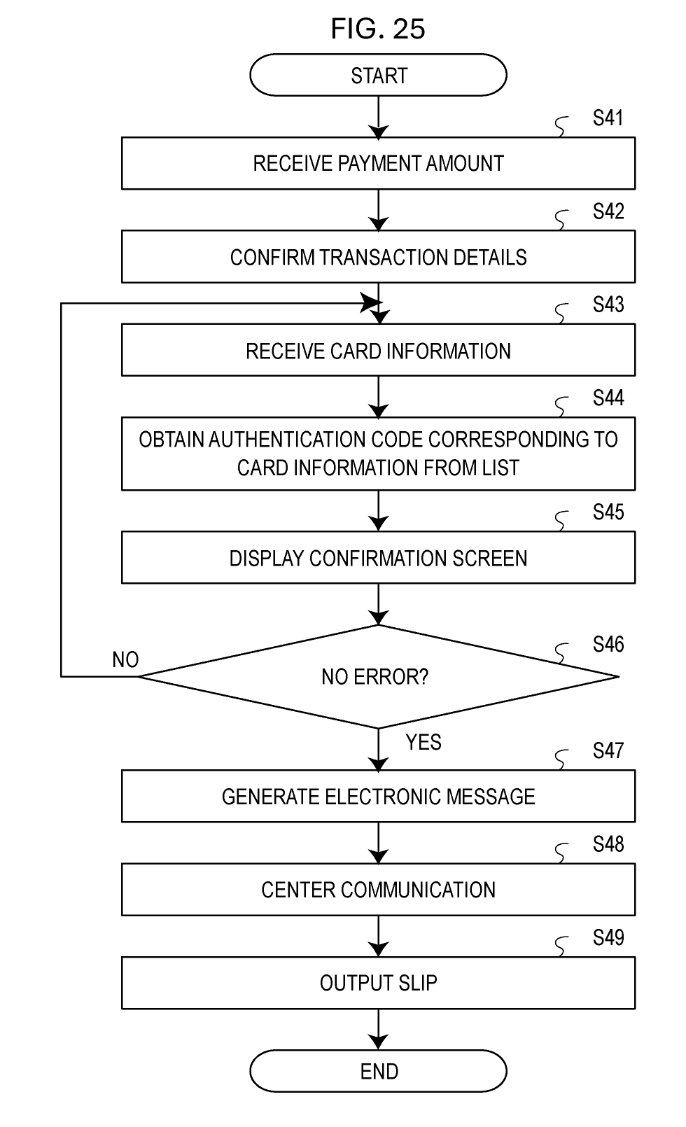

FIG. 25 is a flowchart illustrating an example of a process performed by the control unit 30 of the payment terminal 3. The process illustrated in the flowchart is another example of the process related to payment using pre-authorization illustrated in FIG. 15. The processor (or CPU 31) of the payment terminal 3 may be configured to execute a program stored in a memory (e.g., the storage unit 34 or the RAM 33) to perform the steps in the process described below.

In the present embodiment, the control unit 30, as the post-authorization sales processing unit 304, first receives an input of a transaction amount (step S41), confirms transaction details (step S42), and receives an input of card information (step S43). In other words, the processor is configured to control the display device to display screens for prompting an operator to input an actual transaction amount and to newly input card information. Since these steps S41 to S43 are the same as steps S1 to S3 or steps S23 to S25, detailed descriptions of these steps are omitted.

The control unit 30 searches the authorization code list S43 using the card number included in the card information received at step file 343 as a key, reads a record including the card number, and thereby obtains an authorization code corresponding to the card information (step S44). In other words, the processor is configured to read, from the memory, a record that includes the card information corresponding to the newly input card information.

Subsequently, the control unit 30 displays a confirmation screen and requests the operator to confirm the transaction details (step S45). The confirmation screen includes, for example, the card number, the information acquired at step S44 (that is, the authorization code and the date and time), and a UI component for receiving confirmation from the operator.

When the operator operates the UI component on the confirmation screen to confirm the transaction details (step S46_Yes), the control unit 30 proceeds to next step S47. When the operator performs an operation to indicate that there is an error in the transaction details displayed on the confirmation screen (step S46_No), the control unit 30 returns to step S43.

Steps S47 to S49 are the same as steps S27 to S29, and therefore descriptions of these steps are omitted. That is, the processor is configured to control the communication interface to transmit the authorization information in the read record, the actual transaction amount, and the newly input card information to the server device to perform credit card payment of the actual transaction amount based on the authorization information.

As described above, according to the second embodiment, the burden of manually inputting information can be further reduced compared with the first embodiment.

Programs to be executed by devices described in the above embodiments may be prestored in, for example, a ROM. Programs to be executed by devices described in the above embodiments may be recorded and provided in a non-transitory computer-readable storage medium, such as a compact disk read-only memory (CD-ROM), a flexible disk (FD), a compact disk recordable (CD-R), or a digital versatile disk (DVD) in an installable file format or an executable file format.

Furthermore, programs to be executed by devices described in the above embodiments may be stored in a computer connected to a network, such as the Internet, and downloaded via the network. Programs to be executed by devices described in the above embodiments may be distributed via a network, such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A system comprising:
a server device configured to manage credit card transactions; and
a payment terminal that is connected via a network to the server device and includes:
a communication interface,
a display device,
a memory, and
a processor configured to execute a program that is stored in the memory to perform pre-authorization and post-authorization processes for executing credit card transactions, wherein
the pre-authorization process includes:
upon receipt of an amount of a scheduled transaction and card information of a credit card to be used for the scheduled transaction, controlling the communication interface to transmit the amount and the card information to the server device to reserve an amount of credit associated with the credit card and corresponding to the amount of the scheduled transaction, and
upon receipt of authorization information confirming reservation of the amount of credit from the server device, storing the authorization information, the amount of the scheduled transaction, and the card information as a record in the memory, and
the post-authorization process includes:
reading one or more records from the memory, and controlling the display device to display a first screen showing one or more pieces of authorization information corresponding to the one or more records in a selectable manner,
upon selection of one of the one or more pieces of authorization information, controlling the display device to display a second screen through which an actual amount of the scheduled transaction corresponding to the selected authorization information can be input, and
upon receipt of the card information corresponding to the selected authorization information, executing the scheduled transaction based on the actual amount using the card information and the selected authorization information.

2. The system according to claim 1, wherein
the payment terminal further includes a printer; and
the pre-authorization process further includes, after storing the record in the memory, controlling the printer to print the authorization information, the amount of the scheduled transaction, and the card information.

3. The system according to claim 1, wherein
the post-authorization process further includes controlling the communication interface to transmit the selected authorization information, the actual amount, and the card information to the server device to perform credit card payment of the actual amount based on the authorization information.

4. The system according to claim 3, wherein
the payment terminal further includes a printer; and
the post-authorization process further includes, upon receipt of a response indicating completion of the credit card payment from the server device, controlling the printer to print transaction details including the actual amount.

5. The system according to claim 1, further comprising:
a card reader/writer that is connected to the payment terminal and configured to read the card information from the credit card.

6. The system according to claim 1, wherein
the first screen displays, for each of the one or more records, the authorization information, a date and time when the pre-authorization process was performed, and the amount of the scheduled transaction stored in the memory.

7. The system according to claim 1, wherein
the post-authorization process further includes, after receiving the input of the actual amount and before executing the scheduled transaction:
controlling the display device to display a confirmation screen including the actual amount and a payment method, and
receiving a confirmation operation via the confirmation screen.

8. The system according to claim 1, wherein
the pre-authorization process further includes deleting the record corresponding to the selected authorization information from the memory after the scheduled transaction is executed.

9. The system according to claim 1, wherein
the memory stores a master file in which item codes identifying items are associated with prices of the items,
the pre-authorization process further includes receiving an input of an item code and storing the item code in the record in the memory, and
the post-authorization process further includes reading the item code from the record and displaying the item code on the second screen.

10. The system according to claim 1, wherein
the first screen is a pop-up window displayed to overlap a screen used for initiating the post-authorization process.

11. A method performed by a payment terminal that is connected via a network to a server device configured to manage credit card transactions, the method comprising:
performing a pre-authorization process that includes:
upon receipt of an amount of a scheduled transaction and card information of a credit card to be used for the scheduled transaction, transmitting the amount and the card information to the server device to reserve an amount of credit associated with the credit card and corresponding to the amount of the scheduled transaction, and
upon receipt of authorization information confirming reservation of the amount of credit from the server device, storing the authorization information, the amount of the scheduled transaction, and the card information as a record in a memory; and
performing a post-authorization process that includes:
reading one or more records from the memory, and displaying a first screen showing one or more pieces of authorization information corresponding to the one or more records in a selectable manner,
upon selection of one of the one or more pieces of authorization information, displaying a second screen through which an actual amount of the scheduled transaction corresponding to the selected authorization information can be input, and
upon receipt of the card information corresponding to the selected authorization information, executing the scheduled transaction based on the actual amount using the card information and the selected authorization information.

12. The method according to claim 11, wherein
the pre-authorization process further includes, after storing the record in the memory, printing the authorization information, the amount of the scheduled transaction, and the card information.

13. The method according to claim 11, wherein
the post-authorization process further includes transmitting the selected authorization information, the actual amount, and the card information to the server device to perform credit card payment of the actual amount based on the authorization information.

14. The method according to claim 13, wherein
the post-authorization process further includes, upon receipt of a response indicating completion of the credit card payment from the server device, printing transaction details including the actual amount.

15. The method according to claim 11, wherein
the card information is read from the credit card using a card reader/writer connected to the payment terminal.

16. The method according to claim 11, wherein
the first screen displays, for each of the one or more records, the authorization information, a date and time when the pre-authorization process was performed, and the amount of the scheduled transaction stored in the memory.

17. The method according to claim 11, wherein
the post-authorization process further includes, after receiving the input of the actual amount and before executing the scheduled transaction:
displaying a confirmation screen including the actual amount and a payment method, and
receiving a confirmation operation via the confirmation screen.

18. The method according to claim 11, wherein
the pre-authorization process further includes deleting the record corresponding to the selected authorization information from the memory after the scheduled transaction is executed.

19. The method according to claim 11, further comprising:
storing in the memory a master file in which item codes identifying items are associated with prices of the items,
the pre-authorization process further includes receiving an input of an item code and storing the item code in the record in the memory, and
the post-authorization process further includes reading the item code from the record and displaying the item code on the second screen.

20. A non-transitory computer-readable storage medium storing a program for causing a processor of a payment terminal connectable to a server device that manages credit card transactions, to perform:
a pre-authorization process that includes:
upon receipt of an amount of a scheduled transaction and card information of a credit card to be used for the scheduled transaction, transmitting the amount and the card information to the server device to reserve an amount of credit associated with the credit card and corresponding to the amount of the scheduled transaction, and
upon receipt of authorization information confirming reservation of the amount of credit from the server device, storing the authorization information, the amount of the scheduled transaction, and the card information as a record in a memory; and
a post-authorization process that includes:
reading one or more records from the memory, and displaying a first screen showing one or more pieces of authorization information corresponding to the one or more records in a selectable manner,
upon selection of one of the one or more pieces of authorization information, displaying a second screen through which an actual amount of the scheduled transaction corresponding to the selected authorization information can be input, and
upon receipt of the card information corresponding to the selected authorization information, executing the scheduled transaction based on the actual amount using the card information and the selected authorization information.
